(19) United States
(12) Patent Application Publication
(10) Pub. No.: US 2013/0075196 A1
(43) Pub. Date: Mar. 28, 2013

(54) STORAGE AND RETRIEVAL APPARATUS

(71) Applicants: Matthias UPMEYER, Borgholzhausen (DE); Andreas Gartemann, Ibbenburen (DE)

(72) Inventors: Matthias UPMEYER, Borgholzhausen (DE); Andreas Gartemann, Ibbenburen (DE)

(73) Assignee: GaUp GmbH, Borgholzhausen (DE)

(21) Appl. No.: 13/429,113

(22) Filed: Mar. 23, 2012

(30) Foreign Application Priority Data
Mar. 24, 2011 (DE) 10 2011 015 054.4

(51) Int. Cl. B65G 1/02; B66F 11/04

(52) U.S. Cl. CPC B65G 1/026; B66F 11/04
USPC 182/148; 182/141

(57) ABSTRACT

A storage and retrieval apparatus for storing loads in and for retrieving loads from storage locations on a rack, in particular a high-bay rack, has a displaceable base body which has a support structure on which a vertically displaceable load-carrying is mounted. The storage and retrieval apparatus also has a personnel platform which is mounted on the base body. The invention, the personnel platform is vertically displaceable independently of the load-carrying.

### CROSS-REFERENCE TO RELATED APPLICATIONS

This application claims the priority of German application no. 10 2011 015 054.4, filed Mar. 24, 2011, and which is incorporated herein by reference.

### FIELD OF THE INVENTION

The invention relates to a storage and retrieval apparatus of the type for storing and retrieving loads in or from storage locations on a rack, in particular a high-bay rack.

### BACKGROUND OF THE INVENTION

These types of storage and retrieval apparatuses are generally known, and are used for a variety of storage operations. Such apparatuses have a base body which is displaceable, for example over rails provided on the floor, and which has a support structure on which a vertically displaceable load-carrying device is mounted. The load-carrying device may have a yoke assembly or a shuttle car, for example. To allow, for example, an operator to observe storage and retrieval operations, for example within the scope of function checks or maintenance activities, the known storage and retrieval apparatuses have a personnel platform, also referred to as a “passenger cab.” In the known storage and retrieval apparatuses, the personnel platform is connected to the load-carrying device, so that the personnel platform follows the vertical motions of the load-carrying device.

### OBJECTS AND SUMMARY OF THE INVENTION

An object of the invention is to provide a storage and retrieval apparatus, in particular a high-bay rack, having expanded functionality.

The basic concept of the invention lies in decoupling vertical motions of the personnel platform from the vertical motions of the load-carrying device. According to the invention, the personnel platform is therefore vertically displaceable independently of the load-carrying device.

This results in significant advantages in practice. In the known storage and retrieval apparatuses, if a malfunction occurs, for example during a storage or retrieval operation at a storage location in a high-bay rack, as the result of which the load-carrying device is no longer vertically movable, for example due to tilting of a pallet to be stored, it is necessary to carry out operations at the particular vertical position of the load-carrying device in order to eliminate the malfunction. Since in the known storage and retrieval apparatuses the personnel platform is coupled to the vertical motion of the load-carrying device, the personnel platform is not available for this purpose, so that the operator must climb ladders to the level of the load-carrying device. This is not only time-consuming and laborious, but also hazardous, since high-bay racks may have a height of 30 meters, for example. After diagnosing the malfunction which has occurred, it may be necessary for the operator to climb the ladders multiple times, for example if a tool is required for eliminating a malfunction. This increases the effort and the time expenditure, as well as the hazard potential.

One particular advantage of the invention is that the personnel platform may be used for diagnosing malfunctions, since the personnel platform is vertically displaceable independently of the load-carrying device, and therefore is available even when the load-carrying device is blocked in a vertical position. To diagnose and possibly eliminate a malfunction, in a storage and retrieval apparatus according to the invention an operator enters the personnel platform at floor level and then moves the personnel platform into the vertical region where the load-carrying device is located. At the level of the load-carrying device, the operator is then able to determine the type of malfunction that is present and the particular operations necessary for eliminating it. Due to the independent vertical displaceability of the personnel platform, the operator is able to view the load-carrying device from various levels, thus simplifying the diagnosis of malfunctions.

When the storage and retrieval apparatus, for example and in particular, is designed in such a way that the load-carrying device may be operated from the personnel platform, for example via a mobile control unit, the operator may be able to eliminate malfunctions without leaving the personnel platform. For example, the operator may eliminate malfunctions in the vertical direction as well as in the storage and retrieval direction by manually controlled displacement motions of the load-carrying device. As a result of the invention, the diagnosis and elimination of malfunctions is thus less time-consuming and much less laborious. In addition, the risk to operators is significantly reduced, since on the one hand the operator covers a vertical path to the load-carrying device via the personnel platform instead of by climbing a ladder, and on the other hand malfunctions may be eliminated, from the personnel platform, without the operator climbing into the storage rack.

The invention thus significantly expands the functionality of storage and retrieval apparatuses.

In principle, the personnel platform may be mounted on its own support structure. To keep the design of the storage and retrieval apparatus simple, one advantageous further embodiment provides that the personnel platform is mounted on the support structure of the base body.

In sum, the invention includes a storage and retrieval apparatus for storing loads in and for retrieving loads from storage locations on a rack, in particular a high-bay rack, the apparatus including a displaceable base body having a support structure on which a vertically displaceable load-carrying device is mounted. There is a personnel platform mounted on the base body, and the personnel platform is vertically displaceable independently of the load-carrying device.

The support structure of the base body of the storage and retrieval apparatus according to the invention may be designed in any desired, suitable manner, depending on the particular requirements, and the personnel platform may be mounted thereon.

In this regard, one advantageous further embodiment provides that the support structure has at least one column on which the personnel platform is mounted.

According to another advantageous further embodiment, the support structure has at least two columns which are provided at a distance from one another, and joined together at their upper end by a crossbar. In this type of design, the load-carrying device may be accommodated between the columns so as to be displaceable in the vertical direction, while the personnel platform may be mounted in a vertically displaceable manner at a surface of one of the columns facing away from the load-carrying device.

To increase the safety for the operator, another advantageous further embodiment of the invention provides that the personnel platform is provided with a cage or a cab. An appropriate cage may be designed, for example, as a partial cage that is open at the top. A particularly high level of safety results when the personnel platform is provided with a cab which completely or at least partially encloses the operator.

A displacement drive for vertically displacing the personnel platform may be designed in any desired, suitable manner. In this regard, one advantageous further embodiment of the invention provides that a displacement drive driven by an electric motor is associated with the personnel platform.

Another advantageous further embodiment of the invention provides that a control device for controlling the personnel platform independently of the load-carrying device is associated with the personnel platform. In this embodiment, the control device associated with the personnel platform may be formed by separate hardware, which may be provided, for example, in a control cabinet on the base body of the load-carrying device. However, the control device may also be part of a control device which controls the entire storage and retrieval apparatus.

To further expand the functionality of the storage and retrieval apparatus according to the invention, one extremely advantageous further embodiment of the invention provides a mobile control unit which is connectable or connected via at least one interface to a load-carrying device control device in such a way that the load-carrying device is operable from the personnel platform via the mobile control unit. By way of such a mobile control unit, which may also be referred to as a mobile panel, operators are able in particular to manually control the load-carrying device in order to thus eliminate malfunctions.

Another advantageous further embodiment of the invention provides that the personnel platform is displaceable in the vertical direction in a continuously variable or approximately continuously variable manner. In this way, the personnel platform may be placed at any desired position in the vertical direction for diagnosing or eliminating malfunctions, so that the operator is able, for example, to view the location of the malfunction from different heights. According to the invention, displaceability in a continuously variable or approximately continuously variable manner is also understood to mean quasi-continuously variable displaceability, which results, for example, when the personnel platform is vertically displaced using a rack and pinion gear.

The invention may be integrated into the design of storage and retrieval apparatuses. According to the invention, however, it is also possible to equip existing storage and retrieval apparatuses with a personnel platform which according to the invention is vertically displaceable independently of the load-carrying device. The invention further includes that an appropriate retrofit kit or device for retrofitting a storage and retrieval apparatus with a personnel platform which is vertically displaceable independently of a load-carrying device of the storage and retrieval apparatus. In such a retrofit kit or device, the personnel platform and its mounting on the storage and retrieval apparatus may be designed as set forth in detail herein regarding the storage and retrieval apparatus.

A storage system according to the invention may in particular be designed as a high-bay rack and have at least one storage and retrieval apparatus according to the invention as set forth herein.

The invention is explained in greater detail below with reference to the appended drawings, which schematically illustrate an embodiment of a storage and retrieval apparatus according to the invention. All features described, illustrated in the drawings, and claimed in the patent claims constitute the subject matter of the invention, alone or in any given combination, independently of their combination in the patent claims or their dependencies, and independently of their description or illustration in the drawings.

Relative terms, such as left, right, up, and down, are for convenience only and are not intended to be limiting.

### BRIEF DESCRIPTION OF THE DRAWINGS

FIG. 1 shows a schematic diagram of a storage and retrieval apparatus according to an embodiment of the invention, with the personnel platform in a first vertical position;

FIG. 2 shows, in the same manner as FIG. 1; the storage and retrieval apparatus according to FIG. 1 with the personnel platform in a second vertical position; and

FIG. 3 shows, in the same manner as FIG. 1, the storage and retrieval apparatus according to FIG. 1 with the personnel platform in a third vertical position.

### DETAILED DESCRIPTION OF THE INVENTION

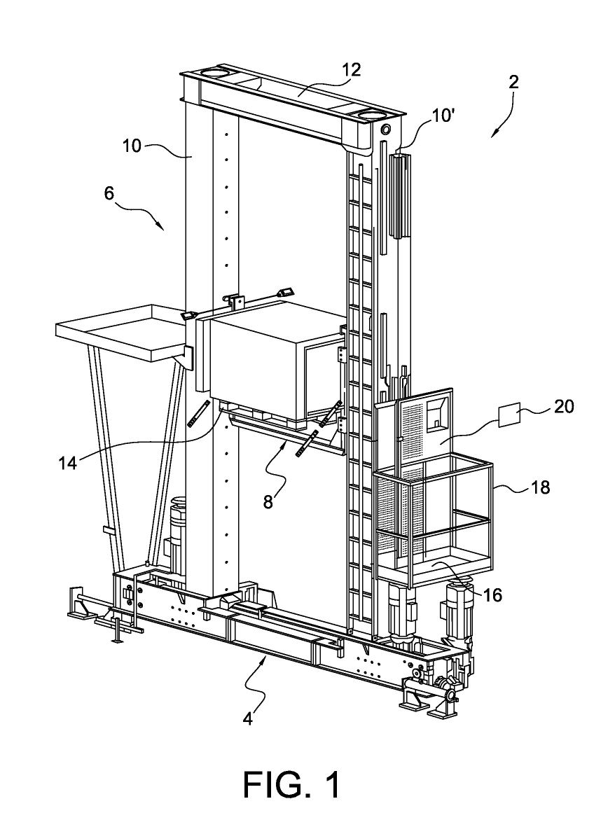

FIG. 1 illustrates an embodiment of a storage and retrieval apparatus 2 according to the invention for storing and retrieving loads in or from storage locations of a rack, in particular a high-bay rack. The storage and retrieval apparatus 2 has a base body 4 which is displaceable along rails, for example, and which has a support structure 6 on which a vertically displaceable load-carrying device 8 is mounted. In the illustrated embodiment 2, the support structure 6 has columns 10, 10′ which are provided at a distance from one another, and joined together at their upper end by a crossbar 12. The load-carrying device 8 is provided between the columns 10, 10′ so as to be vertically displaceable. The load-carrying device 8 may have a yoke assembly or a shuttle car, for example, for carrying out storage and retrieval operations. In FIG. 1, a loaded pallet 14 is provided on the load-carrying device 8 as an example of a load to be stored or retrieved.

In other respects, the design and the mode of operation of a corresponding storage and retrieval apparatus 2, in addition to the load-carrying device 8, are generally known to those of ordinary skill in the art and therefore are not described in greater detail herein.

The storage and retrieval apparatus 2 also has a personnel platform 16 which according to the invention is vertically displaceable independently of the load-carrying device 8. For this purpose, a vertical displacement drive designed as a rack and pinion gear, driven by an electric motor, whose gear rack is mounted at the surface of the column 10′ facing away from the load-carrying device is associated with the personnel platform 16. A control device is associated with the personnel platform 16 in order to control the personnel platform 16 independently of the load-carrying device 8.

In the illustrated embodiment, the personnel platform 16 is provided with a cage 18, which in the illustrated embodiment is designed as a partial cage that is open at the top. Instead of the cage 18, however, the personnel platform may be provided with a cab that is closed or at least partially closed.

In the illustrated embodiment, the vertical displacement motion of the personnel platform 16 is controlled via a control device provided on the personnel platform 16, which in the illustrated embodiment is designed as a dead man's control system with two-handed operation. According to the invention, however, control devices having a different design may be used.

Also provided in the illustrated embodiment is a mobile control unit, which is illustrated in a highly schematic manner in the drawing and denoted by reference numeral 20. The mobile control unit 20 is connected via an interface to a load-carrying device control device in such a way that the load-carrying device 8 is operable from the personnel platform 16 via the mobile control unit 20. The control unit 20 may communicate with the load-carrying device control device by way of a wired connection, for example via control lines, or by way of a wireless connection. The interface may be a detachable plug-in connection. Any desired, suitable control units may thus be connected to the load-carrying device control device via a plug-in connection, in particular in the region of the personnel platform 16. According to the invention, however, it is also possible for the control unit 20 to be permanently installed on the personnel platform 16. The operator may manually control the load-carrying device 8 via the control unit 20.

The dimensions of the storage and retrieval apparatus 12, in particular the height of the columns 10, 10′, are illustrated in a strictly schematic manner in the drawings. In practice, the columns 10, 10′ may have a height of approximately 30 meters, for example, in order to operate in storage locations in high-bay racks. In particular when the poles 10, 10′ have a great height, the support structure may have additional reinforcing elements, for example in the manner of a framework structure.

The mode of operation of the storage and retrieval apparatus 2 according to the invention is as follows.

FIGS. 1 through 3 each illustrate the load-carrying device in a vertical position between the floor and the crossbar 12.

According to the invention, the personnel platform 16 is vertically displaceable independently of the load-carrying device, as shown by a comparison of FIGS. 1 through 3. FIGS. 1 through 3 each illustrate the load-carrying device 8 in the same vertical position, while the personnel platform 16 is in different vertical positions.

If a malfunction occurs during operation of the load-carrying device 8, as the result of which the load-carrying device 8 is no longer vertically displaceable, for example, the operator may enter the personnel platform 16 at floor level and move the personnel platform into a vertical position in which the malfunction may be diagnosed and possibly eliminated.

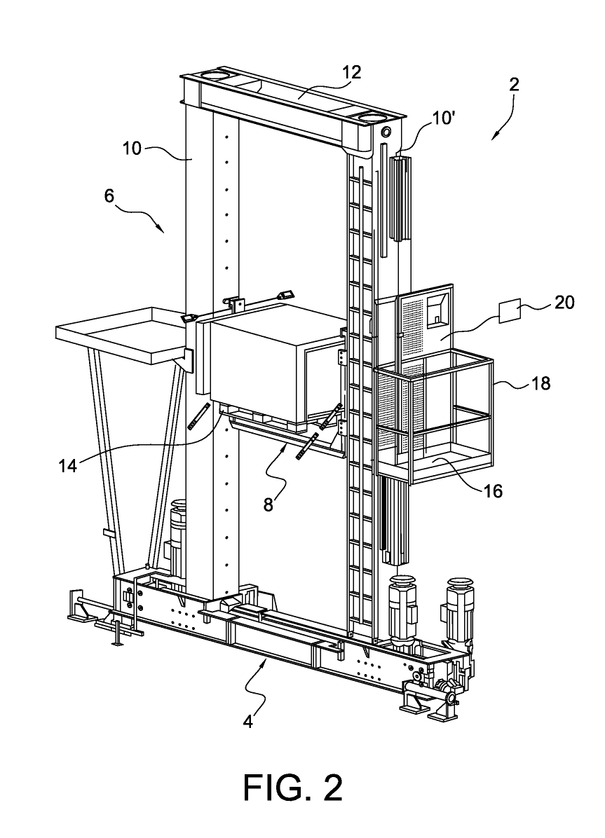

FIG. 2 shows the personnel platform 16 in a vertical position in which the personnel platform is located at the level of the load-carrying device 8.

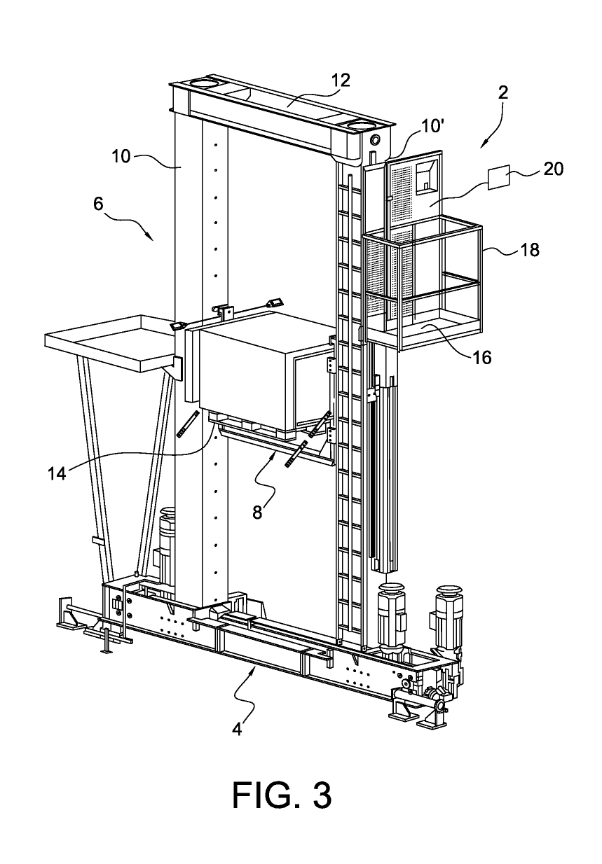

FIG. 3, on the other hand, shows the personnel platform 16 in a vertical position in which the personnel platform is located above the load-carrying device 8.

After diagnosing the malfunction, the operator may then manually activate the load-carrying device 8 via the mobile control unit 20. In this manner it is often possible to eliminate the cause of malfunctions, so that it is no longer necessary for the operator to climb into the storage rack.

The storage and retrieval apparatus according to the invention 2 is thus expanded with regard to its functionality, in particular for diagnosing and eliminating malfunctions. Due to the fact that, in principle, the operator no longer has to climb a ladder to the height of the particular position of the load-carrying device 8 in the event of a malfunction, the risk to the operator is significantly reduced. In addition, malfunctions may be eliminated in a much easier and less time-consuming manner.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention.

What is claimed is:

1. Storage and retrieval apparatus for storing loads in and for retrieving loads from storage locations on a rack, comprising:
a) a displaceable base body being provided, the displaceable base body having a support structure on which a vertically displaceable load-carrying device is mounted;
b) a personnel platform being mounted on the base body; and
c) the personnel platform being vertically displaceable independently of the load-carrying device.

2. Storage and retrieval apparatus according to claim 1, wherein:
a) the personnel platform is mounted on the support structure of the base body.

3. Storage and retrieval apparatus according to claim 1, wherein:
a) the support structure includes at least one column on which the personnel platform is mounted.

4. Storage and retrieval apparatus according to claim 1, wherein:
a) the support structure includes at least two columns which are provided at a distance from each other, and which are joined together at a respective upper end thereof by a crossbar.

5. Storage and retrieval apparatus according to claim 1, wherein:
a) the personnel platform is provided with one of a cage and a cab.

6. Storage and retrieval apparatus according to claim 1, wherein:
a) a displacement drive driven by an electric motor is operatively associated with the personnel platform.

7. Storage and retrieval apparatus according to claim 1, wherein:
a) the a control device for controlling the personnel platform independently of the load-carrying device is provided and is operatively associated with the personnel platform.

8. Storage and retrieval apparatus according to claim 1, wherein:
a) a mobile control unit is provided which is one of connectable and connected via at least one interface to a load-carrying device control device so that the load-carrying device is operable from the personnel platform via the mobile control unit.

9. Storage and retrieval apparatus according to claim 1, wherein:
a) the personnel platform is displaceable in the vertical direction in a substantially continuously variable manner.

10. Retrofit device for retrofitting a storage and retrieval apparatus with a personnel platform which is vertically displaceable independently of a load-carrying device of the storage and retrieval apparatus, the retrofit device comprising:
a) a personnel platform being provided and being mountable on a support structure of the storage and retrieval apparatus;
b) a displacement drive being provided for vertically displacing the personnel platform; and
c) a control device being provided for controlling the displacement drive for vertically displacing the personnel platform.

11. Storage system for a high-bay rack, comprising:
a) a storage and retrieval apparatus for storing loads in and for retrieving loads from storage locations on a high-bay rack, the storage system including:
i) a displaceable base body, the displaceable base body having a support structure on which a vertically displaceable load-carrying device is mounted;
ii) a personnel platform mounted on the base body; and
iii) the personnel platform being vertically displaceable independently of the load-carrying device.
